(19) United States
(12) Patent Application Publication
(10) Pub. No.: US 2008/0255903 A1
(43) Pub. Date: Oct. 16, 2008

(54) BUSINESS PROCESS EXECUTION METHOD, BUSINESS PROCESS ENGINE AND METHOD FOR DEPLOYING A BUSINESS PROCESS ENGINE

(76) Inventors: Ying Liu, Beijing (CN); Wei Tan, Beijing (CN); Jun Zhu, Beijing (CN)

Correspondence Address: IBM CORPORATION, T.J. WATSON RESEARCH CENTER, P.O. BOX 218, YORKTOWN HEIGHTS, NY, 10598, US

(21) Appl. No.: 12/102,199

(22) Filed: Apr. 14, 2008

(30) Foreign Application Priority Data
Apr. 12, 2007 (CN) 200710090499.X

(51) Int. Cl. G06Q 10/00

(52) U.S. Cl. 705/7

(57) ABSTRACT

The present invention provides a business process execution method, a business process engine, a method for deploying a business process engine and a computer program product. According to one aspect of the invention, there is provided a business process execution method, wherein, the business process is predefined by using Business Process Specification Language, said method comprising: performing said business process and monitoring events generated during the execution of said business process; and jumping from one step of said business process to another step based on a preset jumping rule, thereby changing predefined process of said business process.

This application claims priority under 35 U.S.C. § 119 from Chinese Patent Application No. 200710090499.X filed Apr. 12, 2007, the entire contents of which are incorporated herein by reference

### FIELD OF THE INVENTION

The present invention relates to data processing technology, to solve compatibility problems between business processes.

### BACKGROUND OF THE INVENTION

In the current service environment, a lot of services are available through a Business Process Execution Language (BPEL) engine. Currently, there are many products for BPEL engines, such as IBM's WebSphere™ Business Process Server, Active Endpoints's ActiveBPEL™ engine, IBM's BPWS4J product, Oracle's BPEL Process Manager, Bexee, Cape Clear's Orchestrator™ and Parasoft's BPEL Maestro™ etc. A variety of services are available through these BPEL engines.

However, in an actual application environment, it is usually impossible to find exactly matched services. The common situation is that users can find some required services, but these services will include some incompatible functions.

Service incompatibility is a challenging problem for service composition build-time and service composition run-time. Two examples of incompatible services are given below.

(1) In service composition build-time, some services may not be able to be directly composed with other services because of incompatible functions. However, modifying services costs too much.

(2) In a dynamic service environment, service providers often change or upgrade their services, which will impact the service's users. And during service run-time, it is possible that one or more services may have some errors or problems, so avoiding loss of service to the customer is a critical problem. Stopping services because of changes, upgrades or exceptions causes too much loss in business for service users.

Currently, except for having a software developer modify an application program, there is no existing method to solve service incompatibility problems without modifying the services in service composition build-time. In service composition run-time, most of the methods to solve service changes, upgrades or exceptions involve stopping conflicted services. However, modifying services or stopping services costs too much and has a high impact on service consumers.

### SUMMARY OF THE INVENTION

The present invention provides a business process execution method, a business process engine, a method for deploying the business process engine and a computer program product.

According to one aspect of the invention, a business process execution method wherein the business process is predefined by using Business Process Specification Language comprises the steps of:

Performing the business process and monitoring events generated during the execution of the business process and Jumping from one step of the business process to another step based on a preset jumping rule, thereby changing a predefined process of the business process.

According to another aspect of the invention, a business process engine to perform a business process predefined by the Business Process Specification Language, comprises: an event monitoring unit configured to monitor events generated during the execution of the business process and a jumping unit configured to jump the business process from one step of the business process to another step based on a preset jumping rule, thereby changing the predefined process of the business process.

According to another aspect of the invention, a method for deploying the business process engine, wherein the business process engine is used to perform the business process predefined by the Business Process Specification Language, comprises: an event monitoring unit configured to monitor events generated during the execution of the business process; and a jumping unit configured to jump the business process from one step of the business process to another step based on a preset jumping rule, thereby changing the predefined process of the business process.

According to another aspect of the invention, a computer program product that is stored on a computer useable medium, comprises: computer readable program codes for causing a computing means to perform the business process execution method wherein the business process method is predefined by using Business Process Specification Language, and comprises the steps of: Performing the business process, monitoring events generated during the execution of the business process; and jumping from one step of the business process to another step based on a preset jumping rule, thereby changing the predefined process of the business process.

### BRIEF DESCRIPTION OF THE DRAWINGS

It is believed that the above features, advantages and objects of the invention will be better understood from the description of the detailed implementation of the invention in conjunction with accompanying drawings, in which:

FIG. 1A is a flowchart of a business process execution method according to one embodiment of the invention;

FIG. 1B is a detailed flowchart of the business process execution method according to the embodiment of the invention;

FIG. 2 is one example of a jump process according to the embodiment of the invention;

FIG. 3 is another example of the jump process according to the embodiment of the invention;

FIG. 4 is another example of the jump process according to the embodiment of the invention; and

FIG. 5 is a block diagram of a business process engine according to another embodiment of the invention.

### DETAILED DESCRIPTION OF THE PREFERRED EMBODIMENTS

In this section, various preferred embodiments of the invention will be described in detail in conjunction with accompanying drawings.

Business Process Execution Method

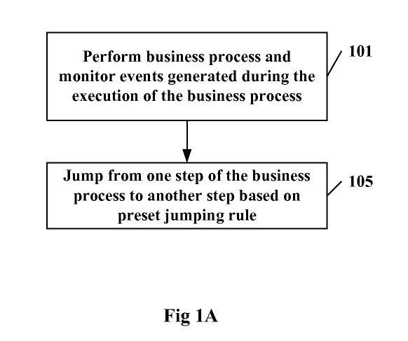

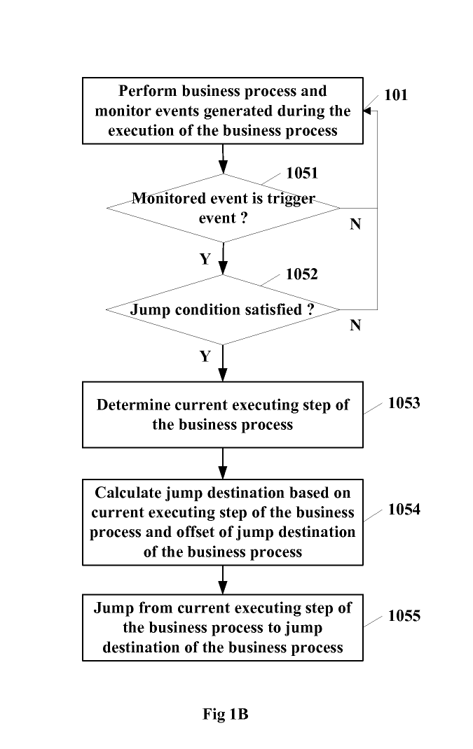

FIG. 1A is a flowchart of a business process execution method according to one embodiment of the invention. As shown in FIG. 1A, first, at step 101, a business process is performed and events generated during the execution of the business process are monitored. Wherein, the business process performed in this step is predefined by using, for example, Business Process Specification Language (BPSL), also known as Business Process Modeling Language (BPML). However, the business process of the present embodiment can also be defined by using other languages known to those skilled in the art or future developed languages, and the invention has no limitation to this.

In the present embodiment, the events generated during the execution of the business process refer to various events which occur during the execution of the business process that can be monitored by a business process engine, such as the event “accept_customer_information” in sending booking service information, and will be described in detail in the following.

For example, in case an IBM WebSphere™ Business Process Server is employed, Common Event Infrastructure (CEI) can be used to monitor the events generated during the execution of the business process. Of course, the invention is not limited to this. For example, Active Endpoints's ActiveBPEL™ engine, IBM's BPWS4J product, Oracle's BPEL Process Manager, Bexee, Cape Clear's Orchestrator™, Parasoft's BPEL Maestro™, and their respective monitoring tools can be used, as long as they can perform a business process and monitor the events generated during the execution of the business process.

Finally, at step 105, the business process is jumped from one step to another step based on a preset jumping rule. The preset jumping rule is set by using Business Process Specification Language according to an Event-Condition-Action (ECA) rule. However, it should be appreciated that the jumping rule can be set by using any language and rule known to those skilled in the art, as long as it can clearly describe the jump condition and jump destination, and the invention has no limitation to this.

Generally, a business process server and engine both have service call functions. For example, in case an IBM WebSphere™ Business Process Server is employed, the above jumping can be realized by using an Adaptive Action Manager. The invention is not limited to this. For example, respective service call functions of Active Endpoints's ActiveBPEL™ engine, IBM's BPWS4J product, Oracle's BPEL Process Manager, Bexee, Cape Clear's Orchestrator™ and Parasoft's BPEL Maestro™ etc can be employed; of course, it can also be realized with additional programs, as long as the above jumping function can be realized when needed, and the invention has no limitation to this.

The jumping rule of the present embodiment mainly includes the following three aspects:

Event: used to define a trigger event for the jumping rule, that is, if it is monitored in step 101 that the events generated during the execution of the business process are consistent with the trigger event, then it is further determined whether a jump condition of the jumping rule is satisfied;

Condition: used to define a jump condition for the jumping rule. If the condition is satisfied, then an action for the jumping rule is performed; if the condition is not satisfied, then the current step of the business process is performed;

Action: used to define a jump destination for the jumping rule, i.e., an activity in the process that should be jumped to, that is, if the jump condition of the jumping rule is satisfied, then the business process is jumped from the currently executing step to the step of the jump destination for the jumping rule.

These aspects are expressed as the following:

On_EVENT EventID IF ConditionExp DO ActionExp

Wherein, EventID represents a trigger event, ConditionExp represents a jump condition, and ActionExp represents a jump destination. It should be appreciated that the jumping rule given herein is just an illustrative form of representation, and the jumping rule can be represented by using any manner known to those skilled in the art, as long as it can be used to realize the jump function.

Specifically, FIG. 1B depicts a detailed flowchart executing a business process method according to a preferred implementation of the above embodiment. After a business process is performed with a business process engine (e.g., IBM's Websphere Process Server) and events generated during the execution of the business process are monitored with an event monitor (e.g., IBM's Websphere Business Monitor) at step 101, at step 1051, it is determined whether the monitored events are trigger events defined in the jumping rule. If the trigger event defined in the jumping rule is monitored in step 1051, then the process proceeds to step 1052. Otherwise, the process returns to step 101.

Next, at step 1052, it is determined whether the jump condition defined in the jumping rule is satisfied. If it is determined at step 1052 that the jump condition of the jumping rule is satisfied, then the process proceeds to step 1053. Otherwise, the process returns to step 101.

Next, at step 1053, the currently executing step of the business process is determined.

Next, at step 1054, a jump destination is calculated based on the currently executing step of the business process and an offset of the jumping rule, wherein details about setting an offset will be described in the following with reference to example 2 and 3. In addition, it should be appreciated that setting an offset is just an optional manner to determine the jump destination. The invention, instead of using an offset, can directly set the jump destination to certain step of the business process, the details of which will be described in the following with reference to examples 1-3.

Finally, at step 1055, the process is jumped from the current executing step of the business process to the jump destination of the jumping rule, thereby realizing the jumping function of the present embodiment.

Next, the jumping process performed in step 105 will be described in detail through examples 1-3.

### Example 1

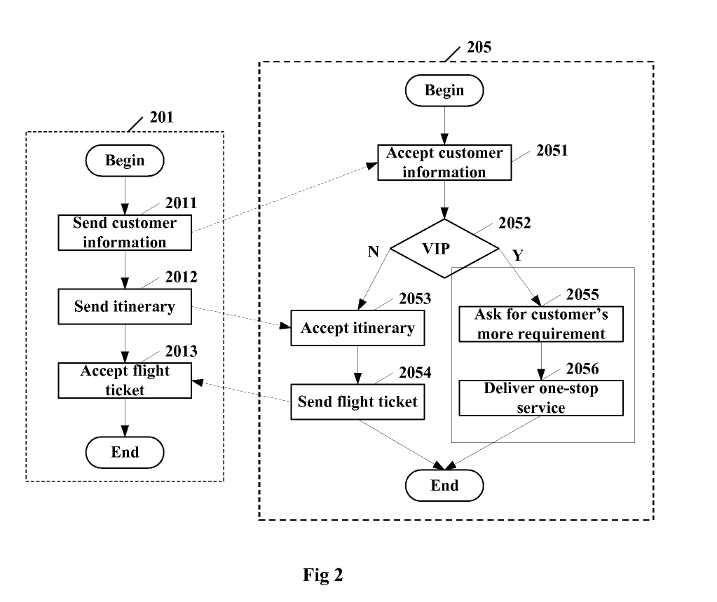

FIG. 2 is one example of a jump process in a business process execution method according to the embodiment of the invention. In FIG. 2, reference number 201 represents a travel agency's booking business process, and reference number 205 represents an airline company's business process. In the airline company's business process 205, in order to provide different services for VIP and non-VIP customers, a determination step 2052 is introduced between step 2051 (accept customer information) and step 2053 (accept itinerary). That is, it is determined in step 2052 whether the customer is a VIP customer, and if not, step 2053 is performed, if yes, the VIP customer is provided with one-stop service at another branch. By the way, after the determination step is introduced, there is incompatibility between booking business process 201 and the airline company's business process 205.

To solve the incompatibility between them, the following jumping rule is set in example 1:

On_EVENT Accept customer_information IF MsgFrom (Booking service) DO Jump (Accept_customer_information, Accept itinerary)

Wherein:

Trigger event (EventID)=Accept_customer_information (Accept customer information)

Jump condition (ConditionExp)=MsgFrom (Booking service) (whether message coming from booking service)

Jump destination (ActionExp)=Jump (Accept_customer_information, Accept itinerary) (jump from accept customer information to accept itinerary)

That is, during execution of a business process, the business process execution method of the present embodiment monitors events generated during the execution of the business process. If the trigger event is monitored, i.e., occurrence of event “Accept_customer_information” is monitored when business process 205 reaches step 2051, then jump condition “whether message coming from booking service” is determined. If the message is not coming from booking business process 201, then business process 205 proceeds to step 2052. If the message is coming from booking business process 201, then a jump step of the jumping rule is performed, that is, the process jumps from current step 2052 to step 2053 (accept itinerary) of the business process 205. Accordingly, incompatibility between booking business process 201 and the airline company's business process 205 is avoided through the business process execution method of the present embodiment.

### Example 2

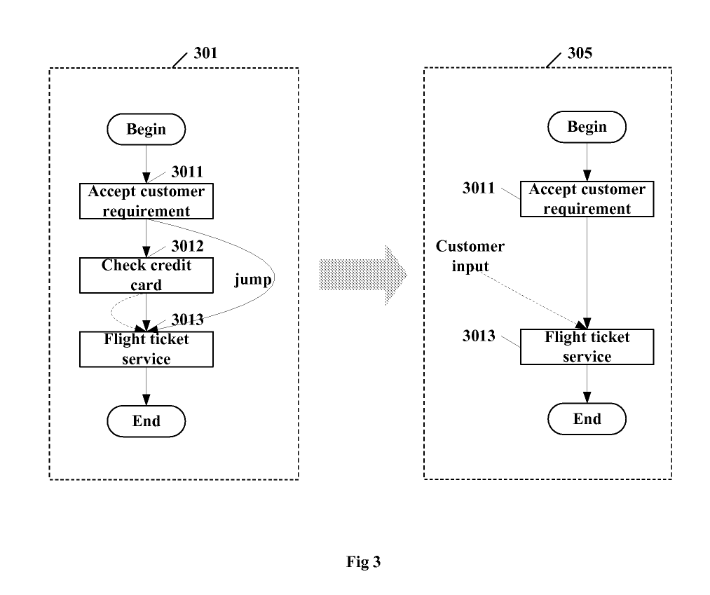

FIG. 3 is another example of a jump process in a business process execution method according to the embodiment of the invention. In FIG. 3, reference number 301 represents a booking business process before a jumping rule is set, and reference number 305 represents a booking business process after a jumping rule is set. In booking business process 301, only a customer with a credit card can use the business process, in order to enable a customer without a credit card to use booking business process 301, the following jumping rule is set in example 2:

On_EVENT Accept_customer_information DO Jump (Accept_customer_information, Ticket_service)

Wherein:

Trigger event (EventID)=Accept_customer_information (Accept customer information)

Jump condition (ConditionExp)=default (that is, jump step is performed as long as trigger event is monitored)

Jump destination (ActionExp)=Jump (Accept_customer_information, Ticket_service) (jump from accept customer information to ticket service)

That is, during execution of business process 301, the business process execution method of the present embodiment monitors events generated during the execution of the business process, if the trigger event is monitored, i.e., occurrence of event “Accept_customer_information” is monitored when business process 301 reaches step 3011, then a jump step of the jumping rule is performed, that is, the process jumps from current step 3011 to step 3013 (ticket service) of the business process 301. Accordingly, with the business process execution method of the present embodiment, a customer without a credit card can use the business process 301 through customer input.

### Example 3

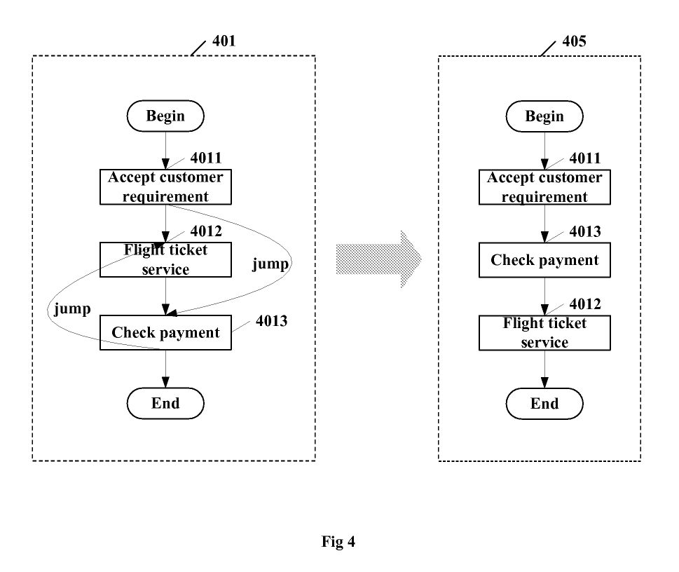

FIG. 4 is another example of a jump process in business process execution method according to the embodiment of the invention. In FIG. 4, reference number 401 represents a booking business process before a jumping rule is set, and reference number 405 represents a booking business process after a jumping rule is set. In booking business process 401, payment status is checked after ticket service, in order to check payment before ticket service, the following two jumping rules are set in example 3:

Jumping Rule 1

On_EVENT Accept customer_information DO Jump (Accept_customer_information, Check_payment)

Wherein:

Trigger event (EventID)=Accept_customer_information (Accept customer information)

Jump condition (ConditionExp)=default (that is, jump step is performed as long as trigger event is monitored)

Jump destination (ActionExp)=Jump (Accept_customer_information, Check_payment) (jump from accept customer information to check payment)

Jumping Rule 2

On_EVENT Check_payment DO Jump (Check_payment, Ticket_service)

Wherein:

Trigger event (EventID)=Check_payment (check payment)

Jump condition (ConditionExp)=default (that is, jump step is performed as long as trigger event is monitored)

Jump destination (ActionExp)=Jump (Check_payment, Ticket_service) (jump from check payment to ticket service)

That is, during execution of business process 401, the business process execution method of the present embodiment monitors events generated during the execution of the business process. If the trigger event of the jumping rule 1 is monitored, i.e., occurrence of event “Accept_customer_information” is monitored when business process 401 reaches step 4011, then a jump step of the jumping rule is performed, that is, jumps from current step 4011 to step 4013 (check payment) of the business process 401. In addition, if the trigger event of the jumping rule 2 is monitored, i.e., occurrence of event “Check_payment” is monitored when business process 401 reaches step 4013, then jump step of the jumping rule is performed, that is, jumps from current step 4013 to step 4012 (ticket service) of the business process 401. Accordingly, with the business process execution method of the present embodiment, the order of the step 4012 and 4013 in business process 401 can be changed.

In the present embodiment, current execution environment of the business process is saved before the step of jumping from current executing step of the business process to the jump destination of the jumping rule, for example, in the above example 1, all the environment variables related to service execution containing customer information received at step 2051 are saved before jumping from step 2051 to step 2053, so that they can be used in subsequent steps.

In addition, in the present embodiment, one or more of the above jumping rules can be set at service composition build-time to avoid incompatibility problems between two or more services, or one or more of the above jumping rules can be set at service run-time to solve errors or abnormal problems that may occur in the service. In addition, one jumping rule or a group of jumping rules can be set for one service or one service composition. However, it should be appreciated that any jumping rule can be set as necessary for any service and at any stage of the service, as long as service incompatibilities and conflicts can be solved without modifying or stopping the service in case the executable service itself is not modified, and the invention has no limitation to this.

Optionally, in the present embodiment, the jump destination of the above jumping rule can be set by using an offset; that is, the jump destination can be calculated based on the currently executing step of the business process and an offset of the jump destination of the jumping rule. For example, in the above example 2, the offset of the jumping rule is set as two steps downwards. When executing the jump step, the process jumps two steps downwards from the current step 3011 of the business process 301, i.e., the process jumps to step 3013. Again for example, in the above example 3, the offset of the jumping rule 2 is set as one step upwards. When executing the jump step of jumping rule 2, the process jumps one step upwards from the current step 4013 of the business process 401, i.e., the process jumps to step 4011.

With the business process execution method of the present embodiment, by setting a jumping rule when composing partially incompatible services, there is no need to modify an executable service itself, thereby cost for service development and reuse can be dramatically reduced.

Further, with the business process execution method of the present embodiment, service providers can set a jumping rule in a relatively stable service, so that they can provide different services for different customers without modifying an executable service itself

Additionally, with the business process execution method of the present embodiment, a service can be upgraded and modified conveniently through modifying the jumping rule, so that there is no need to upgrade and modify the service itself.

In addition, with the business process execution method of the present embodiment, service errors and abnormalities can be solved through setting the jumping rule, and thereby loss caused by stopping service can be significantly reduced.

Business Process Engine

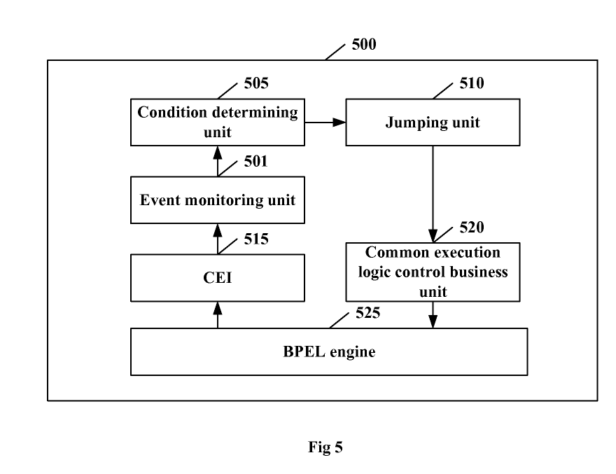

Under the same inventive conception, FIG. 5 is a block diagram of a business process engine according to another embodiment of the invention. Next, the embodiment will be described in conjunction with FIG. 5.

As shown in FIG. 5, the business process engine 500 of the present embodiment is used to perform a business process predefined by using Business Process Specification Language, comprising: an event monitoring unit 501 configured to monitor events generated during the execution of the business process; a condition determining unit 505 configured to determine whether a jump condition of the jumping rule is satisfied when the event monitoring unit 501 monitors the trigger event of the jumping rule; and a jumping unit 510 configured to jump the business process from one step of the business process to another step based on a preset jumping rule, thereby changing the business process.

Optionally, the business process engine 500 of the present embodiment may also include an existing business process engines such as BPEL engine 525. That is, the business process engine 500 of the present embodiment can be obtained by performing an extension or improvement based on BPEL engine 525. BPEL engine 525 includes, for example, IBM's WebSphere™ Business Process Server, Active Endpoints's ActiveBPEL™ engine, IBM's BPWS4J product, Oracle's BPEL Process Manager, Bexee, Cape Clear's Orchestrator™ and Parasoft's BPEL Maestro™ etc. In addition to BPEL engine 525, an extension or improvement can also be performed based on other business process engines known to those skilled in the art, and the invention has no limitation to this.

Optionally, the business process engine 500 of the present embodiment may also include other existing parts that are well known, such as Common Event Infrastructure (CEI) 515, which is configured to capture events generated during execution of business process by BPEL engine 525. In addition to CEI 515, other products known to those skilled in the art may also be used to realize this function, such as BEA Weblogic's Tuxedo™ Event Broker/Monitor, and Oracle's Business Activity Monitor, etc., and the invention has no limitation to this.

Optionally, the business process engine 500 of the present embodiment may also include other existing parts that are well known, such as Common Execution Logic Control Business Unit 520, which is configured to interact between jumping unit 510 and BPEL engine 525, thereby realizing a jump function.

For details about other known parts of business process engine 500, see Dongsoo Han and Jaeyong Shim' document “A Framework Supporting Dynamic Workflow Interoperation and Enterprise Application Integration”, Proceedings of the 35th Hawaii International Conference on System Sciences, 2002, the contents of which are hereby incorporated by reference (referred to hereafter as document 1).

In the present embodiment, the business process performed by business process engine 500 is predefined by using, for example, Business Process Specification Language (BPSL) (also known as Business Process Modeling Language, (BPML)). However, the business process of the present embodiment can also be defined by using other languages known to those skilled in the art or future developed languages, and the invention has no limitation to this.

In the present embodiment, the events generated during the execution of the business process monitored by event monitoring unit 501 refer to various events which occurred during the execution of the business that can be monitored by a business process engine, such as the event “accept_customer_information” in sending booking service, and it will be described in detail in the following.

In the present embodiment, the preset jumping rule is set by using Business Process Specification Language according to an Event-Condition-Action (ECA) rule. However, it should be appreciated that the jumping rule can be set by using any language and rule known to those skilled in the art, as long as a jump function can be realized when needed, and the invention has no limitation to this.

The jumping rule of the present embodiment mainly includes the following three aspects:

Event: used to define a trigger event for the jumping rule, that is, if it is monitored by event monitoring unit 501 that the events generated during the execution of the business process are consistent with the trigger event, then it is further determined whether a jump condition of the jumping rule is satisfied;
Condition: used to define a jump condition for the jumping rule, if the condition is satisfied, then an action for the jumping rule is performed, if the condition is not satisfied, then the current step of the business process is performed;
Action: used to define a jump destination for the jumping rule, i.e., an activity in the process that should be jumped to, that is, if the jump condition of the jumping rule is satisfied, then the business process is jumped from the currently executing step to the step of the jump destination for the jumping rule.

These aspects are expressed as the following:

On_EVENT EventID IF ConditionExp DO ActionExp

Wherein, EventID represents a trigger event, ConditionExp represents a jump condition, and ActionExp represents a jump destination. It should be appreciated that the jumping rule given herein is just an illustrative form of representation, and the jumping rule can be represented by using any manners known to those skilled in the art, as long as they can be used to realize the jump function.

Next, the jumping process performed by jumping unit 510 will be described in detail through examples 1-3.

### Example 1

FIG. 2 is one example of a jump process of business process engine 500 according to the embodiment of the invention. In FIG. 2, reference number 201 represents a travel agency's booking business process, and reference number 205 represents an airline company's business process. In the airline company's business process 205, in order to provide different services for VIP and non-VIP customers, a determination step 2052 is introduced between step 2051 (accept customer information) and step 2053 (accept itinerary), that is, it is determined in step 2052 whether the customer is a VIP customer, if not, step 2053 is performed, if yes, the VIP customer is provided with one-stop service at another branch. By the way, after the determination step is introduced, there is incompatibility between the booking business process 201 and airline company's business process 205.

To solve the incompatibility between them, the following jumping rule is set in example 1:

On_EVENT Accept_customer_information IF MsgFrom (Booking service) DO Jump (Accept_customer_information, Accept itinerary)

Wherein:

Trigger event (EventID)=Accept_customer_information (Accept customer information)

Jump condition (ConditionExp)=MsgFrom (Booking service) (whether message coming from booking service)

Jump destination (ActionExp)=Jump (Accept_customer_information, Accept itinerary) (jump from accept customer information to accept itinerary)

That is, during execution of a business process, the business process engine 500 of the present embodiment monitors events generated during the execution of the business process with event monitoring unit 501, and when the event monitoring unit 501 monitors the trigger event, i.e., occurrence of event “Accept_customer_information” is monitored when business process 205 reaches step 2051, use condition determining unit 505 to determine whether jump condition “whether message coming from booking service” is satisfied. If the message is not coming from booking business process 201, then business process 205 proceeds to step 2052. If the message is coming from booking business process 201, then the jump step of the jumping rule is performed by using jumping unit 510, that is, the step jumps from current step 2052 to step 2053 (accept itinerary) of business process 205. Accordingly, incompatibility between booking business process 201 and airline company's business process 205 is avoided through the business process engine 500 of the present embodiment.

### Example 2

FIG. 3 is another example of a jump process of business process engine 500 according to the embodiment of the invention. In FIG. 3, reference number 301 represents a booking business process before a jumping rule is set, and reference number 305 represents a booking business process after a jumping rule is set. In booking business process 301, only a customer with a credit card can use the business process, in order to enable a customer without a credit card to use booking business process 301, the following jumping rule is set in example 2:

On_EVENT Accept customer requirement DO Jump (Accept customer requirement, Ticket_service)

Wherein:

Trigger event (EventID)=Accept customer requirement (Accept customer requirement)

Jump condition (ConditionExp)=default (that is, jump step is performed as long as trigger event is monitored)

Jump destination (ActionExp)=Jump (Accept customer requirement, Ticket_service) (jump from accept customer requirement to ticket service)

That is, during execution of business process 301, the business process engine 500 of the present embodiment monitors events generated during the execution of the business process with event monitoring unit 501, and when the event monitoring unit 501 monitors the trigger event, i.e., occurrence of event “Accept customer requirement” is monitored when business process 301 reaches step 3011, jumping unit 510 is used to perform jump step of the jumping rule, that is, jumps from current step 3011 to step 3013 (ticket service) of the business process 301. Accordingly, with the business process engine 500 of the present embodiment, a customer without a credit card can use the business process 301 through customer input.

### Example 3

FIG. 4 is another example of a jump process of business process engine 500 according to the embodiment of the invention. In FIG. 4, reference number 401 represents a booking business process before a jumping rule is set, and reference number 405 represents a booking business process after a jumping rule is set. In booking business process 401, payment status is checked after a ticket service. In order to check payment before a ticket service, the following two jumping rules are set in example 3:

Jumping Rule 1

On_EVENT Accept customer requirement DO Jump (Accept customer requirement, Check_payment)

Wherein:

Trigger event (EventID)=Accept customer requirement (Accept customer requirement)

Jump condition (ConditionExp)=default (that is, a jump step is performed as long as a trigger event is monitored)

Jump destination (ActionExp)=Jump (Accept customer requirement, Check_payment) (jump from accept customer requirement to check payment)

Jumping Rule 2

On_EVENT Check_payment DO Jump (Check_payment, Ticket_service)

Wherein:

Trigger event (EventID)=Check_payment (check payment)

Jump condition (ConditionExp)=default (that is, a jump step is performed as long as a trigger event is monitored)

Jump destination (ActionExp)=Jump (Check_payment, Ticket_service) (jump from check payment to ticket service)

That is, during execution of business process 401, the business process engine 500 of the present embodiment monitors events generated during the execution of the business process with event monitoring unit 501, and when the event monitoring unit 501 monitors the trigger event of the jumping rule 1, i.e., occurrence of event “Accept customer requirement” is monitored when business process 401 reaches step 4011, jumping unit 510 is used to perform a jump step of the jumping rule, that is, jump from current step 4011 to step 4013 (Check payment) of the business process 401. In addition, when the event monitoring unit 501 monitors the trigger event of the jumping rule 2, i.e., occurrence of event “Check_payment” is monitored when business process 401 reaches step 4013, jumping unit 505 is used to perform a jump step of the jumping rule, that is, jump from current step 4013 to step 4012 (ticket service) of the business process 401. Accordingly, with the business process engine 500 of the present embodiment, the order of the step 4012 and 4013 in business process 401 can be changed.

In the present embodiment, the business process engine 500 further comprises an environment saving unit configured to save the current execution environment of the business process before Jumping unit 510 performs the step of jumping from the currently executing step of the business process to the jump destination of the jumping rule. For example, in the above example 1, all the environment variables related to service execution containing customer information received at step 2051 are saved before jumping from step 2051 to step 2053, so that they can be used in subsequent steps.

In addition, in the present embodiment, business process engine 500 can set one or more of the above jumping rules at service composition build-time to avoid incompatibility problems between two or more services, or set one or more of the above jumping rules at service run-time to solve error or abnormal problems that may occur in the service. In addition, business process engine 500 can set one jumping rule or a group of jumping rules for one service or one service composition. However, it should be appreciated that, business process engine 500 can set any jumping rule as necessary for any service and at any stage of the service, as long as service incompatibilities and conflicts can be solved without modifying or stopping the service in case the executable service itself is not modified, and the invention has no limitation to this.

Optionally, in the present embodiment, the jump destination of the above jumping rule can be set by using an offset, that is, the jump destination of the jumping unit 510 can be calculated based on the currently executing step of the business process and an offset of the jump destination of the jumping rule. For example, in the above example 2, the offset of the jumping rule is set as two steps downwards. When executing the jump step, the process jumps two steps downwards from the current step 3011 of the business process 301, i.e., jumps to step 3013. Again for example, in the above example 3, the offset of the jumping rule 2 is set as one step upwards. When executing the jump step of jumping rule 2, the process jumps one step upwards from the current step 4013 of the business process 401, i.e., jumps to step 4011.

With the business process engine 500 of the present embodiment, by setting a jumping rule when composing partially incompatible services, there is no need to modify an executable service itself, thereby costs for service development and reuse can be dramatically reduced.

Further, with the business process engine 500 of the present embodiment, service providers can set a jumping rule in a relatively stable service, so that they can provide different services for different customers without modifying the executable service itself.

Additionally, with the business process engine 500 of the present embodiment, a service can be upgraded and modified conveniently through modifying the jumping rule, so that there is no need to upgrade and modify the service itself.

In addition, with the business process engine 500 of the present embodiment, service errors and abnormalities can be solved through setting the jumping rule, and thereby loss caused by stopping service can be significantly reduced.

Method for Deploying a Business Process Engine

Under the same inventive conception, a method is provided for deploying a business process engine according to another embodiment of the invention. Next, the embodiment will be described.

In the method for deploying a business process engine of the present embodiment, the business process engine is used to perform business process predefined by using Business Process Specification Language and comprises: an event monitoring unit configured to monitor events generated during the execution of the business process; and a jumping unit configured to jump the business process from one step of the business process to another step based on a preset jumping rule, thereby changing the process of the business process. In addition, the business process engine deployed by the method of the present embodiment can also be the business process engine 500 in the above embodiment described with reference to FIG. 5.

For details about the method for deploying a business process engine of the present embodiment, see the above Dongsoo Han and Jaeyong Shim' document 1, which will not be described here for brevity.

With the method for deploying a business process engine of the present embodiment, by setting a jumping rule when composing partially incompatible services, there is no need to modify an executable service itself, thereby cost for service development and reuse can be dramatically reduced.

Further, with the method for deploying a business process engine of the present embodiment, service providers can set a jumping rule in a relatively stable service, so that they can provide different services for different customers without modifying an executable service itself.

Additionally, with the method for deploying a business process engine of the present embodiment, service can be upgraded and modified conveniently through modifying the jumping rule, so that there is no need to upgrade and modify the service itself.

In addition, with the method for deploying a business process engine of the present embodiment, service errors and abnormalities can be solved through setting the jumping rule, thereby loss caused by stopping service can be significantly reduced.

Computer Program Product

Under the same inventive conception, there is provided a computer program product according to another embodiment of the invention. Next, the embodiment will be described.

The computer program product of the present embodiment is stored on a computer useable medium, comprising:

Computer readable program code for causing a computing means to perform a business process execution method, wherein, the business process is predefined by using Business Process Specification Language, the method comprising the steps of: performing the business process and monitoring events generated during the execution of the business process; and jumping from one step of the business process to another step based on a preset jumping rule, thereby changing the business process. In addition, the computer program code of the computer program product of the present embodiment may also be used to cause a computing means to perform the business process execution method in the above embodiment described with reference to FIG. 1A.

With the computer program product of the present embodiment, by setting a jumping rule when composing partially incompatible services, there is no need to modify an executable service itself, thereby costs for service development and reuse can be dramatically reduced.

Further, with the computer program product of the present embodiment, service providers can set a jumping rule in a relatively stable service, so that they can provide different services for different customers without modifying an executable service itself.

Additionally, with the computer program product of the present embodiment, a service can be upgraded and modified conveniently through modifying the jumping rule, so that there is no need to upgrade and modify the service itself.

In addition, with the computer program product of the present embodiment, service errors and abnormalities can be solved through setting the jumping rule, and thereby loss caused by stopping service can be significantly reduced.

Although a business process execution method, a business process engine, a method for deploying a business process engine and a computer program product of the present invention have been described through some exemplary embodiments, these embodiments are not exhaustive, those skilled in the art can realize various changes and modifications within the spirit and scope of the invention. Therefore, the present invention is not limited to these embodiments, the scope of which is only defined by appended claims.

1. A business process execution method, wherein the business process is predefined by using Business Process Specification Language, said method comprising the steps of:
performing said business process and monitoring events generated during the execution of said business process; and jumping from one step of said business process to another step based on a preset jumping rule, thereby changing predefined process of said business process.

2. The business process execution method according to claim 1, wherein, said jumping rule at least comprises: a trigger event, a jump condition, and a jump destination.

3. The business process execution method according to claim 2, wherein, said step of jumping from one step of said business process to another step comprises:
determining whether the monitored trigger event of said jumping rule satisfies the jump condition of the jumping rule; and
if the jump condition of the jumping rule is satisfied, jumping from the currently executing step of said business process to the jump destination of the jumping rule.

4. The business process execution method according to claim 3, further comprising:
saving the current execution environment of said business process before said step of jumping from currently executing step of said business process to the jump destination of the jumping rule.

5. The business process execution method according to claim 4, wherein, the jump destination of the jumping rule is set by using offset, and the step of jumping from the currently executing step of said business process to the jump destination of the jumping rule comprises the steps of: determining the currently executing step of said business process; and calculating the jump destination based on the currently executing step of said business process and offset of the jump destination of the jumping rule.

6. A business process engine for performing business process predefined by using Business Process Specification Language, comprising:
an event monitoring unit configured to monitor events generated during the execution of said business process; and a jumping unit configured to jump said business process from one step of said business process to another step based on a preset jumping rule, thereby changing the predefined process of said business process.

7. The business process engine according to claim 6, wherein, said jumping rule at least comprises: a trigger event, a jump condition, and a jump destination.

8. The business process engine according to claim 7, wherein, further comprising:
a condition determining unit configured to determine whether the monitored trigger event of said jumping rule satisfies the jump condition of the jumping rule;
wherein, if the jump condition of the jumping rule is satisfied, said jumping unit jumps said business process from currently executing step of said business process to the jump destination of the jumping rule.

9. The business process engine according to claim 8, further comprising:
an environment saving unit configured to save current execution environment of said business process before said step of jumping from currently executing step of said business process to the jump destination of the jumping rule.

10. The business process engine according to claim 9, wherein, the jump destination of the jumping rule is set by using offset; said jumping unit is configured to determine the currently executing step of said business process, and calculate the jump destination based on the currently executing step of said business process and offset of the jump destination of the jumping rule.

11. A method for deploying a business process engine, the business process engine is used to perform business process predefined by using Business Process Specification Language and comprises:
an event monitoring unit configured to monitor events generated during the execution of said business process; and
a jumping unit configured to jump said business process from one step of said business process to another step based on a preset jumping rule, thereby changing the predefined process of said business process.
